(19) United States
(12) Patent Application Publication
(10) Pub. No.: US 2024/0342927 A1
(43) Pub. Date: Oct. 17, 2024

(54) Manual Robotic Tool Changer with Generally Opposed Decoupling Actuation Force and Safety Latch Actuation Force

(71) Applicant: ATI Industrial Automation, Inc., Apex, NC (US)

(72) Inventors: Derek Alan Faust, Durham, NC (US); Lucas Lauren Larson, Holly Springs, NC (US)

(21) Appl. No.: 18/135,489

(22) Filed: Apr. 17, 2023

(51) Int. Cl. B25J 15/04

(52) U.S. Cl. CPC B25J 15/0425; B25J 15/0416

(57) ABSTRACT

A manual robotic tool changer includes a coupling mechanism. The coupling mechanism is activated by moving a lever between open (decoupled) and closed (coupled) positions. When the lever reaches the closed position, a safety latch automatically engages and prevents the lever from moving towards the open position. To open the lever, the safety latch is first activated to disengage, then the lever is moved to the open position. To virtually eliminate the possibility of both the safety latch being accidentally actuated, and the lever being accidentally moved towards the open position, these actions require the application of forces in substantially opposite directions. Accordingly, it is impossible that a single force, inadvertently applied to any part of the tool changer, could both actuate the safety latch and open the lever. In some embodiments, actuation of the safety latch and opening the lever are both easily performed with one hand.

### FIELD OF DISCLOSURE

The present disclosure relates generally to manual robotic tool changers, and in particular to manual robotic tool changers having a handle opened by force applied in a first direction, the handle having a safety latch disengaged by force applied in a generally opposite direction to the first direction.

### BACKGROUND

Industrial robots have become an indispensable part of modern manufacturing. Whether transferring semiconductor wafers from one process chamber to another in a cleanroom or cutting and welding steel on the floor of an automobile manufacturing plant, robots perform many manufacturing tasks tirelessly, in hostile environments, and with high precision and repeatability.

In many robotic manufacturing applications, the considerable cost of an industrial robot is amortized over a variety of tasks by providing different tools, or end effectors, that may be coupled to a general-purpose robotic arm. For example, in an automotive manufacturing application, a robot may be utilized to cut, grind, or otherwise shape metal parts during one production run, and perform a variety of spot welding tasks in another. Furthermore, even in performing one type of task, a robot may utilize different tools. For example, different welding tool geometries may be advantageously mated to a particular robot to perform welding tasks at different locations or in different orientations.

In these applications, a robotic tool changer is used to mate different tools to the robot. One half of the tool changer, called the master assembly, is permanently affixed to a robot arm. The other half, called the tool assembly, is affixed to each tool that the robot may utilize. When a robotic controller aligns the master assembly at the end of a robot arm to a tool assembly attached to the desired tool (typically resting in a tool holder), it directs the master assembly to mechanically couple to the tool assembly, thus attaching the tool to the robot. Similarly, when the tool is safely disposed in a tool stand after a robotic operation, the controller directs the master assembly to decouple from the tool assembly, allowing the robot to move to, and attach, a different tool. In some robotic operations—for example, those in which robotic tools are rarely, if ever, changed-manually actuated robotic tool changers are safely utilized with industrial robots. In this case the robot arm is typically parked in a “safe” position and its automatic actuation disabled, while a person attaches or detaches a robotic tool. Both automatic and manually actuated robotic tool changers also facilitate the provision of utilities-such as electrical current, air pressure, hydraulic fluid, cooling water, and the like—to the tool(s), and the transfer of data from some tools back to the robotic controller.

A collaborative robot (also known as a “cobot”) is a robot characterized by close proximity to, and in some cases interaction with, humans. Unlike industrial robots, which for example may operate on an automotive assembly line, with humans excluded from the area for safety, cobots and humans work in a shared space, such as when cobots are moving items within a warehouse where humans are performing other tasks. Robotic surgery is another example, where a robot works in close proximity to the surgeon and usually other humans such as nurses, anesthesiologists, technicians, and the like. Among other safety features, cobots tend to be much smaller, lighter, and often slower than industrial robots, and they are more limited in the magnitude of forces they can exert. As part of this paradigm, cobots often employ manual robotic tool changers, wherein humans actuate the tool changer to connect and disconnect various tools, or end effectors, so the robot can perform different tasks. Examples of manual robotic tool changers include those described in U.S. Pat. Nos. 7,779,716; 8,500,132; 8,533,930; 8,794,993; 8,857,821; 9,724,830; 10,047,908; 11,555,569, all of which are assigned to the assignee of the present application, and the disclosures of which are incorporated herein by reference in their entireties.

Robotic tool changers employ a wide variety of coupling mechanisms to selectively (de) couple the tool assembly to the master assembly. In industrial robots these are generally automatic, driven by electric motors or pneumatic systems. It is also common for the coupling mechanisms of robotic tool changers to employ safety features, reducing the chances of a tool assembly coming loose from the master assembly, which would present the significant safety hazard of a dropped robotic tool. Examples of robotic tool changer safety features include those described in U.S. Pat. Nos. 6,840,895; 7,252,453; 7,779,716; 8,005,570; 8,209,840; 8,500, 132; 8,533,930; 8,601,667; 8,794,993; 8,857,821; 9,724,830; 10,047,908; 10,661,449; 10,759,061; and 11,555,569, all of which are assigned to the assignee of the present application, and the disclosures of which are incorporated herein by reference in their entireties.

A ball-lock configuration is one known type of robotic tool changer coupling mechanism. In one such configuration, a plurality of rolling members, such as steel balls, is contained in a collar of the master assembly, which is disposed within a chamber of a tool assembly. The balls are driven radially, such as by an advancing piston, and advance to bear against a bearing race in the tool assembly, mechanically coupling the master and tool assemblies together. To decouple, the piston is retracted, and the balls retreat into the collar as the master assembly separates from the tool assembly. Various configurations, driving mechanisms, safety features, and operational aspects of such ball-lock configurations are described in U.S. Pat. Nos. 8,005,570; 8,132,816; 8,209,840; 8,500, 132; 8,533,930; 8,601,667; 8,794,418; 9,151,343; 9,724,830; and 10,335,957. All of these patents are assigned to the assignee of the present application, and the disclosures of all of them are incorporated herein by reference in their entireties.

Safety is a paramount concern in robotic tool changer design and operation. Accordingly, it is known for manually operated robotic tool changers to include a safety latch or interlock, which must be actuated to disengage it, prior to actuating a coupling mechanism to transition the tool changer from a coupled to a decoupled state. However, the utility of such a safety latch may be compromised if the latch is actuated by a force applied in the same general direction as a force required to decouple the tool changer. This type of safety latch presents the hazard that if the latch were accidentally actuated—for example, if a piece of equipment, clothing, wiring, or the like “caught on” or otherwise engaged the safety latch—the safety latch would disengage. Continued application of force in the same direction would subsequently actuate the coupling mechanism, and decouple the master and tool assemblies, creating the hazard of a tool drop.

The Background section of this document is provided to place aspects of the present disclosure in technological and operational context, to assist those of skill in the art in understanding their scope and utility. Approaches described in the Background section could be pursued, but are not necessarily approaches that have been previously conceived or pursued. Unless explicitly identified as such, no statement herein is admitted to be prior art merely by its inclusion in the Background section.

### SUMMARY

The following presents a simplified summary of the disclosure in order to provide a basic understanding to those of skill in the art. This summary is not an extensive overview of the disclosure and is not intended to identify key/critical elements of aspects of the disclosure or to delineate the scope of the disclosure. The sole purpose of this summary is to present some concepts disclosed herein in a simplified form as a prelude to the more detailed description that is presented later.

According to one or more aspects described and claimed herein, a manual robotic tool changer comprising a master assembly and a tool assembly includes a coupling mechanism. The coupling mechanism is activated by moving a lever between open (decoupled) and closed (coupled) positions. When the lever reaches the closed position, a safety latch automatically engages and prevents the lever from moving towards the open position. To open the lever, the safety latch is first activated to disengage, then the lever is moved to the open position. To virtually eliminate the possibility of both the safety latch being accidentally actuated, and the lever being accidentally moved towards the open position, these actions require the application of forces in substantially opposite directions. Accordingly, it is impossible that a single force, inadvertently applied to any part of the tool changer, could both actuate the safety latch and open the lever. Additionally, in some embodiments, both actuation of the safety and moving the lever to (de) couple the tool changer, are accomplished with one hand. This is an important safety feature, as a technician typically is supporting and/or positioning the tool with the other hand.

One aspect relates to a manual robotic tool changer. The tool changer includes a master assembly configured to be connected to a robot; a tool assembly configured to be connected to a robotic tool; a manually actuated coupling mechanism configured to selectively couple the master and tool assemblies together; a lever configured to actuate the coupling mechanism; and a safety latch configured to automatically lock the lever in a closed position in which the master and tool assemblies are coupled, and to allow the lever to move to an open position to decouple the master and tool assemblies only when the safety latch is actuated. An actuating force required to actuate the safety latch in a substantially opposite direction to an opening force required to move the lever towards the open position.

Another aspect relates to a method of operating a manual robotic tool changer comprising a master assembly configured to be connected to a robot, a tool assembly configured to be connected to a robotic tool, and a manually actuated coupling mechanism configured to selectively couple the master and tool assemblies together. To couple the master and tool assemblies together, a lever, configured to selectively actuate the coupling mechanism, is moved from an open position to a closed position. To decouple the master and tool assemblies, a safety latch is actuated, and the lever is moved from the closed position to the open position. An actuating force required to actuate the safety latch is in a substantially opposite direction to an opening force required to move the lever towards the open position.

### BRIEF DESCRIPTION OF THE DRAWINGS

The present disclosure will now be described more fully hereinafter with reference to the accompanying drawings, in which aspects of the disclosure are shown. However, this disclosure should not be construed as limited to the aspects set forth herein. Rather, these aspects are provided so that this disclosure will be thorough and complete, and will fully convey the scope of the disclosure to those skilled in the art. Like numbers refer to like elements throughout.

FIG. 1 is a perspective view of a decoupled manual robotic tool changer.

FIG. 2 is a side view of a coupled manual robotic tool changer.

FIGS. 3A-3C are section views of the manual robotic tool changer.

FIGS. 4A-4C are section views of alternate safety latch aspects.

FIG. 5 is a flow diagram of a method of operating a manual robotic tool changer.

### DETAILED DESCRIPTION

For simplicity and illustrative purposes, the present disclosure is described by referring mainly to an exemplary aspect thereof. In the following description, numerous specific details are set forth in order to provide a thorough understanding of the present disclosure. However, it will be readily apparent to one of ordinary skill in the art that the present disclosure may be practiced without limitation to these specific details. In this description, well known methods and structures have not been described in detail so as not to unnecessarily obscure the present disclosure.

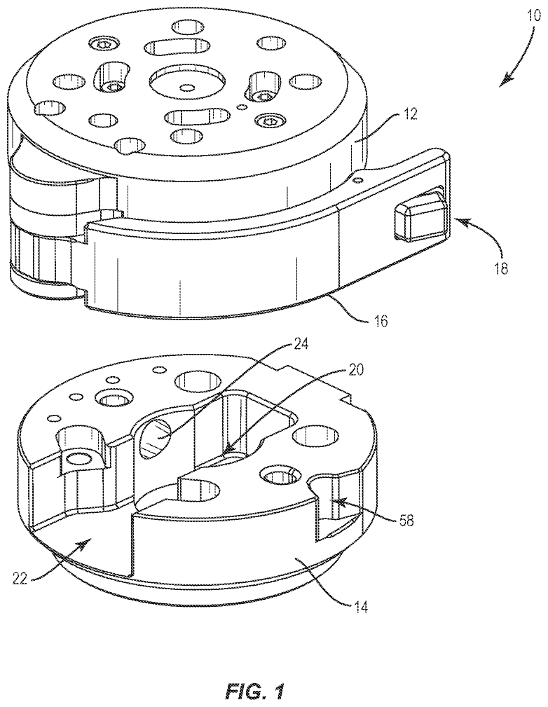

FIG. 1 depicts a perspective view of a manual robotic tool changer 10 in a decoupled state, according to one aspect of the present disclosure. The manual robotic tool changer 10 comprises a master assembly 12 and tool assembly 14. The master assembly includes a lever 16 with a safety latch 18. The master assembly 12 is configured to be attached to a robot arm (not shown), and a copy of the tool assembly 14 is configured to be attached to each tool (not shown) the robot may utilize. Those of skill in the art will readily appreciate that these attachments may be reversed; accordingly, the terms “master” and “tool” assembly are terms of reference only.

As shown, the tool assembly 14 includes a central chamber 20. When the master assembly 12 and tool assembly 14 abut, a coupling mechanism (not shown) in the master assembly 12 lies within the central chamber 20. A channel 22 connects the central chamber 20 to the exterior. As shown, the channel 22 is sized and shaped to receive a hinging portion of the lever 16. One socket 24 is visible in the side wall of the chamber 20. Also visible in FIG. 1 is a latch locking recess 58 formed in the outer portion of the tool assembly 14, which is configured to interact with the safety latch 18, as further described herein.

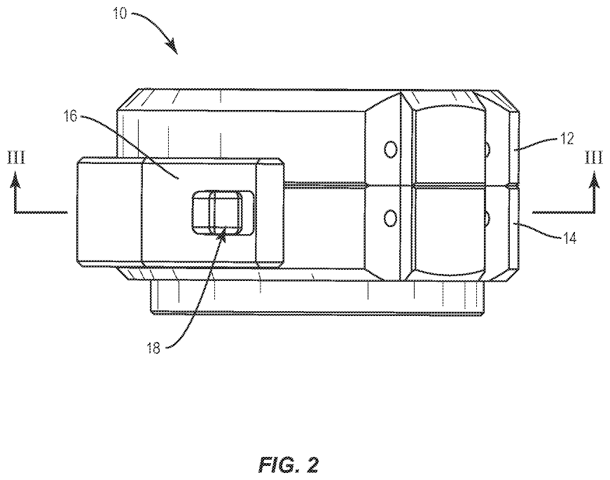

FIG. 2 is a side view of the manual robotic tool changer 10 in a couped state, with the master assembly 12 and tool assembly 14 locked together by a coupling mechanism (not shown in FIG. 2). Although the lever 16 is attached to the master assembly 12, the lever 16 extends below the master assembly 12, and primarily overlies the tool assembly 14 when the manual robotic tool changer 10 is in a coupled state.

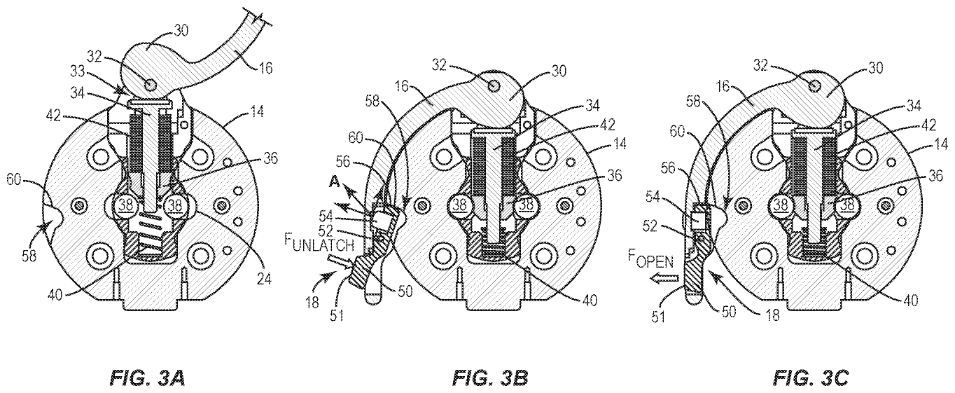

The section views of FIGS. 3A-3C depict the coupling mechanism 33, and overall operation of the manual robotic tool changer 10. Operation of the manual robotic tool changer 10 is described herein with reference to the orientation depicted in FIGS. 3A-3C. That is, the terms, “down,” “left,” and the like are used for convenience. Those of skill in the art will readily recognize that these terms of reference apply only when the manual robotic tool changer 10 is in the orientation depicted in FIGS. 3A-3C.

FIG. 3A depicts the master assembly 12 abutting the tool assembly 14, but with the tool changer 10 in a decoupled state, with the lever 16 extended outwardly away from the master and tool assemblies 12, 14. The lever 16 includes an eccentric pivotal portion 30, which pivots about a lever pivot pin 32 as the lever 16 is moved through its range of motion. Because the lever pivot pin 32 is not located in the center of the eccentric pivotal portion 30, as the lever 16 closes, the eccentric pivotal portion 30 of the lever 16 drives a piston 34 forward (downward). In the decoupled state depicted in FIG. 3A, the piston 34 is in a fully retracted position, and is biased towards that position (upwardly) by a spring 40.

Attached to the piston 34 are cam surfaces 36, which contact ball members 38. In the retracted position of FIG. 3A, the ball members fully retract within a housing of the coupling mechanism 33 in the master assembly 12.

As the lever 16 is moved toward the closed position (i.e., counterclockwise), where it lies adjacent to the master assembly 12 body, the eccentric pivotal portion 30 of the lever 16 forces the piston 34 to advance (move downwardly). As the piston 34 advances, the cam surfaces 36 force the ball members 38 to partially protrude from the coupling mechanism 33 and into corresponding sockets 24 in the central chamber 20 of the tool assembly 14 (FIG. 1). The sockets 24 are sized and shaped to receive the ball members 38. The containment of ball members 38 in the sockets 24 mechanically couples the master and tool assemblies 12, 14 together.

FIG. 3B shows the tool changer 10 in a coupled state, with the lever 16 fully closed and lying against the sides of the master and tool assemblies 12, 14. As described further herein, the safety latch 18 automatically engages to lock the lever 16 in the closed position. The piston 34 is fully advanced, pressing the ball members 38 firmly into corresponding sockets 24 formed in the central chamber 20 of the tool assembly 14. A stack of Belleville spring washers 42 is interposed between the aft end of the piston 34 and the cam surfaces 36. These compress as the piston 34 advances, and provide a continuous forward bias (downwardly) to the cam surfaces 36. This counters the effects of tolerance stack and wear, ensuring that the cam surfaces 36 are always pressed fully forward (downward) when the coupling mechanism 33 is in the coupled state.

As depicted in FIGS. 3B and 3C, when the lever 16 is in the fully closed position, the eccentric pivotal portion 30 of the lever 16 is “over center,” whereby the point of contact between the piston 34 and the eccentric pivotal portion 30 has passed the point of maximum distance from the lever pivot pin 32. To move the lever 16 towards the open position, to decouple the master and tool assemblies 12, 14, the eccentric pivotal portion 30 must first advance the piston 34 slightly further (downwardly), against the force of the spring washers 42 and spring 40. This provides some inherent safety, as the lever 16 exhibits resistance to being opened, requiring a not-insignificant force to open the lever 16. While this over center design resists accidental decoupling of the tool changer 10 by humans, the lever 16 can still be opened if another tool, clothing, wiring, or the like were to “hook” the lever 16 and apply a generally outwardly directed force to it.

As a further safety feature, the lever 16 includes a safety latch 18. In the aspect depicted in FIGS. 3A-3C, the safety latch 18 includes a latch body 50 pivotally mounted to the lever 16 by a latch pivot pin 52. A latch spring 54 biases the latch body 50 to pivot, such that one end of the latch body 50 is automatically disposed in the latch locking recess 58 formed in the tool assembly 14 when the lever 16 is moved to the closed position. When the end of the latch body 50 is disposed in the latch locking recess 58, a latch interference surface 56 at the end of the latch body 50 contacts a tool interference surface 60 of the latch locking recess 58. Due to the bias of the latch spring 54, the end of the latch body 50 is automatically disposed within the latch locking recess 58 whenever the lever 16 is moved to the closed position, as depicted in FIG. 3B.

FIG. 3C depicts the force vector F_{OPEN}, representing an initial force that must be applied at the distal end of the lever 16 to move the lever 16 from the closed position of FIGS. 3B and 3C toward the open position of FIG. 3A. As depicted, this force is directly away from the tool changer 10 (to the left). Due to its arcuate shape and orientation around the side of the tool changer 10, as lever 16 moves outwardly from the tool changer 10, it also moves upwardly. For example, in FIG. 3B, the direction of motion of the lever 16 at the latch locking recess 58 is depicted by an arrow A. Decomposing this direction of motion into orthogonal components shows that it includes a component normal to the interface between the latch interference surface 56 and the tool interference surface 60. The tool interference surface 60 of the latch locking recess 58 disallows this component of motion, and thus prevents the latch body 50, and hence the lever 16, from moving under the applied force F_{OPEN}.

The safety latch 18 is actuated by applying a force F_{UNLATCH} to an actuation surface 51 of the latch body 50. This causes the latch body 50 to pivot (counterclockwise), about the latch pivot pin 52, against the bias of the latch spring 54, removing the end of the latch body 50 from the latch locking recess 58 in the tool assembly 14. In this position, as depicted in FIG. 3C, the latch interference surface 56 no longer contacts the tool interference surface 60, and the lever 16 may freely move under the applied force F_{OPEN}. Note that, due to the position of the safety latch 18, and in particular, the actuation surface 51, near the end of the lever 16, both actuation of the safety latch 18 and moving the lever towards the open position, can easily be accomplished with one hand. For example, on could curl several fingers around the end of the lever 16 (between the distal end of the lever 16 and the tool assembly 14), whilst positioning the thumb of the same hand over the actuation surface 51. In this position, actuating the safety latch 18 is a normal-indeed, almost incidental-part of opening the lever 16.

The lever 16 opening force F_{OPEN} and the safety latch 18 actuation force F_{UNLATCH} act in substantially opposite directions. As those of skill in the art know, a mechanical force may be represented mathematically by a vector having three qualities: magnitude (length), direction (angle), and sense (which end of the vector line has an arrowhead). As used herein, two forces act in “substantially opposite directions” when they have opposite sense and their directions differ by no more than 90°—that is, the force vectors are at an acute or right angle to each other. Through this range of direction, the unlatching force F_{UNLATCH} has no vector component oriented in the same direction as the opening force F_{OPEN}. More preferably, the forces' directions differ by no more than 45°, in which case a component of the unlatching force directly opposed to the opening force is equal to or greater than a component of the unlatching force orthogonal to the opening force. Still more preferably, the forces' directions differ by no more than 20° wherein a component of the unlatching force directly opposed to the opening force is substantially greater than a component of the unlatching force orthogonal to the opening force. Most preferably, the forces' directions differ by no more than 5°, as depicted in FIGS. 3B and 3C. With a safety latch 18 that requires an actuation force in a substantially opposite direction to the lever 16 opening force, the chance of an inadvertent opening of the lever 16 is virtually eliminated. This dramatically improves the safety of manual robotic tool changers 10 according to aspect of the present disclosure, as compared to those in the prior art.

The safety latch 18 depicted in FIGS. 3A-3C is only one aspect of the present disclosure. A variety of other safety latches may be utilized, all of which share the feature that they are actuated by a force in a substantially opposite direction to the force required to open the lever 16.

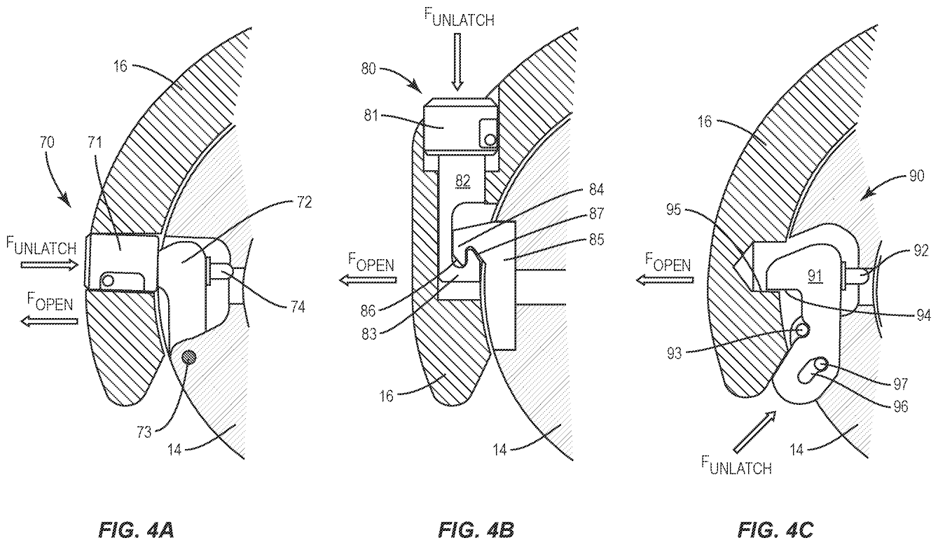

FIG. 4A depicts a safety latch 70 in which the unlatching force F_{UNLATCH} required to open the lever 16 is directly opposite to the lever 16 opening force F_{OPEN}. In this safety latch 70, a latching member 72 engages with a bore in the lever 16 to provide interference that prevents the lever 16 from moving towards the open position. The latching member 72, which is secured to the tool assembly 14 by a pivot pin 73, is actuated by a button 71 disposed in the bore in the lever 16. The latching member 72 is biased to the extended (locked) position by a spring-loaded plunger 74. The button 71 moves with lever 16 and as lever 16 closes, the latching member 72 pushes the button outwardly (to the left) so it protrudes from the lever 16.

FIG. 4B depicts a safety latch 80 in which the unlatching force F_{UNLATCH} required to open the lever 16 is perpendicular to the lever 16 opening force F_{OPEN}. In the safety latch 80, pressing down on the button 81 lowers a shaft 82, with a hook 83 formed therein on the opposite end as the button 81. This disengages the hook 83 from a corresponding hook 84 formed in a latch member 85 affixed to the tool assembly 14. An angled surface 87 on the hook 83 contacts an angled surface 86 on the hook 84 as the lever 16 closes, thus automatically actuating the safety latch 80.

FIG. 4C depicts a safety latch 90 in which the unlatching force F_{UNLATCH} required to open the lever 16 is in a direction of 45° to the lever 16 opening force F_{OPEN}. The safety latch 90 comprises a latch member 91 biased towards the lever 16 by a spring-loaded plunger 92. In the forward position, a latching surface 94 contacts an interference surface 95 formed in the lever 16, preventing the lever 16 from opening. Pressing the latching member 91 in the direction indicated moves the latching member 91 towards the tool assembly 14, disengaging the surfaces 94 and 95. The motion of the latching member 91 is constrained by a slot 96 formed in the latching member 91, which captures a pin 97 affixed to the tool assembly 14. The latching surface 94 automatically engages the lever 16 interference surface 95 when the lever 16 moves to the closed position.

In each of the safety latches 70, 80, 90 depicted in FIGS. 4A, 4B, and 4C, respectively, the unlatching force F_{UNLATCH} required to open the lever 16 is in a substantially opposite direction to the lever 16 opening force F_{OPEN}, as that term is used herein.

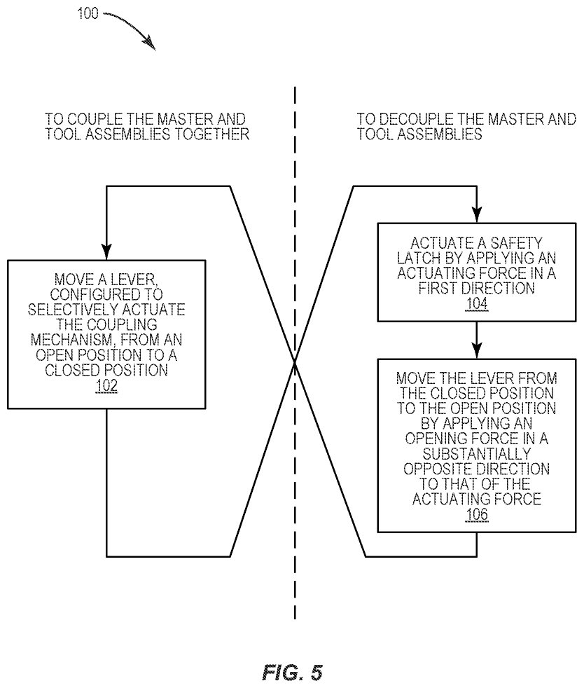

FIG. 5 depicts the steps in a method 100 of operating a manual robotic tool changer 10. The manual robotic tool changer 10 comprises a master assembly 12 configured to be connected to a robot, a tool assembly 14 configured to be connected to a robotic tool, and a manually actuated coupling mechanism 33 configured to selectively couple the master and tool assemblies 12, 14 together. The method is divided into two operations: coupling the master and tool assemblies 12, 14 together, and decoupling the master and tool assemblies 12, 14. To couple the master assembly 12 to the tool assembly 14, a lever 16, which is configured to selectively actuate the coupling mechanism 33, is moved from an open position to a closed position (block 102). A safety latch 18, 70, 80, 90 automatically engages when the lever 16 reaches the closed position. To decouple the master and tool assemblies 12, 14, first the safety latch 18, 70, 80, 90 is actuated by applying an actuating force in a first direction (block 104). Next, the lever 16 is moved from the closed position to the open position by applying a force to the lever that is in a substantially opposite direction to the actuating force (block 106).

Aspects of the present disclosure present significant safety advantages over the prior art. Inadvertent opening of the manual tool changer 10 is virtually impossible. First, the “over center” design of the coupling mechanism 33, along with the resistance provided by spring washers 42 and return spring 40, provides a resistance to moving the lever 16 from the closed towards the open position. Accordingly, even without a safety latch 18, 70, 80, 90, once placed in a coupled state, the manual tool changer 10 will not open under normal use (e.g., from forces incident to use of an attached tool, shock, vibration, or the like). Furthermore, the provision of a safety latch 18, 70, 80, 90 ensures that the lever 16 does not open even if the lever 16 engages some object, such as another robot or tool, wiring, clothing, or the like. Still further, because an actuating force F_{UNLATCH} required to actuate the safety latch 18, 70, 80, 90 is in a substantially opposite direction to an opening force F_{OPEN} required to move the lever 16 towards the open position, it is virtually impossible that any such accidental engagement of the lever 16 could simultaneously actuate the safety latch 18, 70, 80, 90, as in manual tool changer designs in the prior art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the aspects disclosed herein may be applied to any other aspect, wherever appropriate. Likewise, any advantage of any of the aspects may apply to any other aspects, and vice versa. Other objectives, features, and advantages of the enclosed aspects will be apparent from the description. As used herein, the term “configured to” means set up, organized, adapted, or arranged to operate in a particular way; the term is synonymous with “designed to.”

The present disclosure may, of course, be carried out in other ways than those specifically set forth herein without departing from essential characteristics of the disclosure. The present aspects are to be considered in all respects as illustrative and not restrictive, and all changes coming within the meaning and equivalency range of the appended claims are intended to be embraced therein.

What is claimed is:

1. A manual robotic tool changer, comprising:
a master assembly configured to be connected to a robot;
a tool assembly configured to be connected to a robotic tool;
a manually actuated coupling mechanism configured to selectively couple the master and tool assemblies together;
a lever configured to actuate the coupling mechanism; and
a safety latch configured to automatically lock the lever in a closed position in which the master and tool assemblies are coupled, and to allow the lever to move to an open position to decouple the master and tool assemblies only when the safety latch is actuated;
wherein an actuating force required to actuate the safety latch is in a substantially opposite direction to an opening force required to move the lever towards the open position.

2. The tool changer of claim 1, wherein the lever is pivotally connected to the master assembly, and partially overlies the tool assembly when the master and tool assemblies are coupled together.

3. The tool changer of claim 2, wherein the safety latch comprises:
a latch body pivotally disposed within the lever about a latch pivot; and
a latch spring configured and positioned so as to urge one end of the latch body into a latch locking recess in the tool assembly when the lever is a closed position with the master and tool assemblies coupled together;
whereby a tool interference surface in the latch locking recess contacts a latch interference surface at the end of the portion of the latch body disposed in the latch locking recess, preventing the latch body from exiting the latch locking recess as the lever attempts to move to an open position to decouple the master and tool assemblies.

4. The tool changer of claim 3, wherein when the actuating force is applied to an actuation surface of the latch body opposite the latch pivot from the end of the latch body disposed in the latch locking recess, the latch body is moved out of the latch locking recess and away from the tool interference surface, allowing the lever to move to the open position.

5. The tool changer of claim 2, wherein an end of the lever pivotally connected to the master assembly comprises an eccentric pivotal portion and wherein a lever pivot pin connecting the lever to the master assembly is not located in the center of the eccentric pivotal portion.

6. The tool changer of claim 5, wherein the coupling mechanism comprises:
a piston moveable along a longitudinal axis between retracted and advanced positions;
a spring biasing the piston towards a retracted position;
a plurality of ball members disposed radially around the piston; and
cam surfaces connected to the piston and configured to displace the ball members radially outwardly as the piston advances towards the advanced position.

7. The tool changer of claim 6, wherein the tool assembly comprises a corresponding plurality of cavities, each sized and shaped to receive a ball member as the ball members are moved radially outwardly from the piston axis.

8. The tool changer of claim 6, wherein the coupling mechanism further comprises a plurality of spring washers around the piston, the spring washers providing a biasing force urging the cam surfaces towards the advanced position when the coupling mechanism couples the master assembly to the tool assembly.

9. The tool changer of claim 1, wherein lever and safety latch are positioned such that both actuating the safety latch and moving the lever towards the open position can be accomplished with one hand.

10. A method of operating a manual robotic tool changer comprising a master assembly configured to be connected to a robot, a tool assembly configured to be connected to a robotic tool, and a manually actuated coupling mechanism configured to selectively couple the master and tool assemblies together, comprising:
to couple the master and tool assemblies together, moving a lever, configured to selectively actuate the coupling mechanism, from an open position to a closed position; and
to decouple the master and tool assemblies:
actuating a safety latch; and
moving the lever from the closed position to the open position;
wherein an actuating force required to actuate the safety latch is in a substantially opposite direction to an opening force required to move the lever towards the open position.

11. The method of claim 10 wherein the safety latch is configured to automatically lock the lever in the closed position.

12. The method of claim 10 wherein actuating a safety latch and moving the lever from the closed position to the open position can both be performed with one hand.
